(19) United States
(12) Patent Application Publication
(10) Pub. No.: US 2023/0152100 A1
(43) Pub. Date: May 18, 2023

(54) Navigation Methods Using Virtual Celestial Objects

(71) Applicant: Enrique Sernik, Merrimack, NH (US)

(72) Inventor: Enrique Sernik, Merrimack, NH (US)

(21) Appl. No.: 17/753,062

(22) PCT Filed: Nov. 17, 2021
(86) PCT No.: PCT/US2021/072473

§ 371 Date: Feb. 17, 2022

(51) Int. Cl. G01C 21/02; G01C 21/16

(52) U.S. Cl. CPC G01C 21/02; G01C 21/165

(57) ABSTRACT

A method of navigating from a known initial position at a known initial time to a new position at a predetermined delta time of an observer, the method comprising the steps of determining a number of virtual celestial objects for a desired degree of accuracy, generating orbital data for each of the VCOs, receiving at the initial time plus the delta time a parameter from a sensor that provides at least one parameter of the motion of the observer from the prior position, retrieving the orbital data previously generated for the initial time plus the delta time, calculating the new position to within the desired degree of accuracy using the initial position, the parameter, and the VCO orbital data, and, optionally, correcting the inertial navigation system position by using the calculated new position. The method is iteratively repeated as the observer moves.

### TECHNICAL FIELD

The present invention relates to methods and procedures comprising algorithms and/or combinations of algorithms and devices that allow for the determination of and/or provide information regarding one's real-time absolute position throughout uninterrupted, perhaps long, periods of time, in all kinds of environments.

### BACKGROUND ART

Countless military and civilian applications, including many critical infrastructure sectors such as communications, energy, transportation, emergency services, financial services, cloud data centers, to mention just a few, depend on accurate PNT (Position, Navigation, and Timing) data. The problem is commonly referred to in the literature as “the PNT problem,” meaning the capability to not only determine one's real-time location (“P” for position), but also the ability to establish the next desired location (“N” for navigation) and apply the necessary corrections to course, speed, and orientation to do so, with accurate time stamps (“T” for timing) along the way. The term PNT can have other connotations that are made clear in the present specification where it is used. For example, PNT can also refer to looking for position relative to a known landmark.

GPS can provide precise PNT information and has been extensively and successfully employed.

The following description is only intended for clarity and completeness in the description of the invention. The GPS concept is based on the knowledge at all times of the position of a group of satellites (producing recognizable trajectories), called a constellation. Each GPS satellite continuously transmits a radio wave signal containing the current time and data about its position. Since the speed of the wave is constant and independent of the satellites' movements, the time delay between when the satellite transmits the signal and when the receiver receives it is proportional to the distance from the GPS satellite to the GPS receiver. A GPS receiver monitors multiple satellites simultaneously because, in general, the data from at least four satellites is needed to determine the four unknowns that specify the GPS receiver's location: the three dimensional position and the time at the location. In some special cases, three satellites are enough to determine the location.

More precisely, assuming that the distances dᵢ for i=1,2,3,4 from the receiver to four satellites from which the receiver can receive a signal are known and that the exact positions of the satellites xᵢ, yᵢ, zᵢ, for i=1,2,3,4 are also known, in order to determine the receiver location, the following system of four equations and four unknowns must be solved for each time of interest:

\sqrt{(x−x₁)²+(y−y₁)²+(z−z₁)²}+ct_{B}=d₁

\sqrt{(x−x₂)²+(y−y₂)²+(z−z₂)²}+ct_{B}=d₂

\sqrt{(x−x₃)²+(y−y₃)²+(z−z₃)²}+Ct_{B}=d₃

\sqrt{(x−x₄)²+(y−y₄)²+(z−z₄)²}+ct_{B}=d₄ (1)

where c is the speed of light. The unknowns in equation system (1) are t_{B}, the time delay between when the satellites transmit the signal and when the receiver receives it, and x, y, and z, the three-dimensional position of the receiver.

In reality, the equations (1) are rarely known exactly, and what gets solved is a system of equations that approximately describe the distances between the satellites and the receiver. Since the GPS receiver clock is not perfectly synchronized with the satellites' clocks, the distances dᵢ are in error. For that reason, they are called pseudoranges. Further, the distances from the receiver to each satellite is different, and therefore t_{B} is also an approximation that includes the time offset between the satellites and the receiver clocks which, in general, is also different for each satellite-receiver combination. Finally, the wave emitted by the satellite has to travel through the different layers of the atmosphere where it gets distorted/delayed, introducing additional errors in equation system (1).

Although there are closed form solutions to the non-linear equation system (1) (see Bancroft, S. (January 1985). “An Algebraic Solution of the GPS Equations”. IEEE Transactions on Aerospace and Electronic Systems. AES-21 (1): 56-59.), in most inertial navigation system (INS) applications, the solution to equation system (1) is usually found using iterative numerical methods which are halted when a specified precision that satisfies the needs of the application is reached.

As good as the GPS has been, it has limitations. GPS signals cannot be received underground, underwater, or when blocked by man-made or natural structures. GPS signals can be significantly degraded or unavailable during environmental events, such as solar events, snow, and heavy rain. In addition, for example, in Anti Access, Area Denial (A2/AD) environments, adversaries can completely jam the GPS receivers. Worse, even in open areas, foes can (partially) spoof the GPS signals, thereby making it impossible to know that the GPS signal has been degraded.

Existing solutions address the GPS-denied scenarios by using INSs, which are navigation devices that use a computer, motion sensors (e.g., accelerometers), rotation sensors (e.g., gyroscopes), and mathematical algorithms to continuously calculate the current position (velocity, orientation) of a moving object by using a previously determined position (velocity, orientation) of the moving object without the need for external references. INSs can be supplemented by other sensors and/or speed measuring devices. INS systems and precision clocks may, in general, extend PNT for short periods but are subject to growing drift errors when GPS is not available.

The sensors used in INS systems include, but are not limited to, inertial measurement units (IMUs, mostly of the microelectromechanical systems (MEMS) type), daylight and/or thermal/nighttime cameras, laser-range finders, barometers, speedometers, magnetometers, etc. Other solutions combine the GPS information with landmarks or with digitized, pre-stored two- or three-dimensional road maps.

There are solutions that do not involve the use of GPS information, most notably, celestial navigation. Also, an observer's position can be determined by observing one or more satellites against a background of stars and by determining the angles between the position of the satellites and that of the stars.

All these successful solutions, however, have shortcomings.

The MEMS IMUs are not accurate enough for most applications after 2-10 minutes without the GPS signal. The same is true for speedometers and/or barometers.

Algorithms designed to support real-time navigation by using pre-stored road maps and landmarks are generally sensitive to how the data was digitized (resolution, curvatures). Further, calculations to select the “correct” path at intersections increase computational complexity.

Celestial navigation requires a relatively high quality camera and can only be applied in the twilight interval when the stars and the horizon appear simultaneously. Cloudy days or very sunny days are a problem for celestial navigation. In addition, star sensors are heavy and expensive, and the star recognition calculations can be computation-intensive and time consuming.

Further, the incorporation of additional sensors in an INS increases the size, weight, and power consumption (SWnP) of the INS, thereby possibly limiting its reach, for example, in the case of drones or other unmanned aerial vehicles. The additional sensors also increase complexity, which raises the implementation costs and susceptibility to malfunctions.

Therefore, it is desirable to have relatively simple systems and methods that can provide a low cost and accurate solution to one's position without depending on GPS estimates.

### DISCLOSURE OF THE INVENTION

The present invention is a navigation method where no knowledge of satellites, celestial bodies, or their ephemerides is required. The method requires knowledge of an initial position of the traveler/navigator or vehicle (observer) and of the time (year, month, day, hour, minute, and second) associated with that position. The initial position can be either a starting location if the proposed solution will be used instead of the GPS, or the last known location before a GPS-denied condition occurred.

The method also requires a sensor to track local motion of the observer for extremely short periods of time. The sensor can be, for example, a MEMS IMU, a local camera, or any of the other sensors mentioned above. Since the sensor is only to measure local motion for extremely short periods of time, the accuracy limitations described above are not issues.

The method then employs a mathematical algorithm in conjunction with a reference to compute the updated position, which then becomes the new known position, and method is repeated.

The mathematical algorithm utilizes a reference, referred to as a virtual celestial object (VCO), or set of references that is created by the algorithm itself at start-up. A VCO can be any celestial object for which a closed elliptical orbit can be computed, such as a satellite, planet, or combinations. The VCO requires no measurements or external updates and is therefore independent of the environment in which the INS works.

The choice of the VCO employed, i.e., the kind of VCO created at the start of the algorithm, determines the kind of data that is generated and establishes the mathematical tools used in the algorithm. Artificial satellite data includes distances, and so require corresponding tools. Planet data includes angle, and so require corresponding tools.

Initially, the six Keplerian parameters are generated for as many VCOs as are needed in the application. Depending on the application, the complete data can be generated at initialization, or the data can be generated in real time as required.

Since the VCOs' orbit data directly replaces that of the actual satellites, the same equation system (1) can continue to be used.

The sensor is used to propagate the navigation equations, and the position information provided by the VCOs is used to periodically correct the navigation equations that otherwise will diverge if only the sensor is used.

If the sensor data provides distance and direction, then the VCOs information along with the observer's position provided by the sensor and the pseudoranges rapidly provides a corrected position of the observer at time=initial time+delta time. If the sensor only provides distance, then the VCOs information is used, but this time with the pseudoranges of the previous known position and with the known delta time, to iteratively solve for the position of the observer.

In either scenario, the position obtained can be used in an INS as direct replacement of the GPS by fusing the data information of the sensor and that of the VCOs that otherwise will diverge if only the sensor data is used.

Objects of the present invention will become apparent in light of the following drawings and detailed description of the invention.

### BRIEF DESCRIPTION OF DRAWINGS

For a fuller understanding of the nature and object of the present invention, reference is made to the accompanying drawings, wherein:

FIG. 1 is a graph of samples of two orbits of two Navstar GPS satellites in ECEF coordinates;

FIG. 2 is a graph of two orbits of two VCOs in ECEF coordinates;

FIG. 3 is a chart of sample ECEF numerical coordinates for a Navstar GPS satellite in 10⁷ meters;

FIG. 4 is a chart of sample ECEF numerical coordinates for a VCO in 10⁷ meters; and

FIG. 5 is a block diagram of a generic IMU/GPS navigation system showing replacement of the GPS satellites with VCOs.

### BEST MODES FOR CARRYING OUT THE INVENTION

Throughout the following description and claims, specific terms are used to refer to particular system components. An individual skilled in the art will appreciate that different users/companies may refer to a component by different names. This document does not intend to distinguish between components that differ in name but not in function. In the discussion below and in the claims that follow, the terms “including” and “comprising” are used in an open-ended fashion, and thus should be interpreted to mean “including, but not limited to . . . ”

In addition, the term “algorithm” is intended to mean a high level process or set of rules to be followed in order to solve a specific problem, especially by a computer. This high level process may be comprised of “lower level standard” processes or calculations, of which there could be several for each desired task that render the same result. As one skilled in the art will understand, the following description of the high level algorithm has broad application, and therefore, the discussion of any embodiment is meant only to be exemplary of that embodiment, the description is meant to include all “lower level standard” processes or calculations, and the explanation is not intended to imply that the scope of the disclosure or the claims is limited to that embodiment.

The following discussion is directed to various embodiments of the invention. Even though one or more of these embodiments may be preferred, the embodiments disclosed should not be interpreted, or otherwise used, as limiting the scope of the disclosure or the claims.

The various embodiments of this invention are directed to systems and methods for navigation. Certain embodiments of the present invention comprise systems and methods for dealing with GPS denied situations. In addition, certain embodiments provide better positional accuracy for longer periods of time than existing solutions without increasing SWnP requirements. Some embodiments of the present invention comprise real-time implementations. In some embodiments, an additional benefit is provided since jamming and/or spoofing strategies affecting GPS devices are avoided. In some embodiments, an additional benefit is provided in the form of an early warning system should the real GPS signal be spoofed. Some embodiments of the present invention rely on the a priori knowledge of navigation estimation algorithms.

A feature of the present invention is that no a priori or otherwise knowledge of satellites or their ephemerides is required. Neither is the observation or knowledge of the location of any celestial objects (stars, planets, etc.).

One embodiment of the present invention is a solution to the GPS-denied problem, but the proposed method for calculating PNT can be used in other applications where even an existing GPS signal cannot provide (positional) updates as frequently as it may be needed or may be advantageous/desired to have (e.g., guided bombs). The capability to provide very frequent updates (on position), synchronous or not, is a feature of the proposed solution.

The proposed solution of the present invention requires knowledge of an initial position and knowledge of the time (year, month, day, hour, minute, and second) associated with that position. This is a minor requirement since the initial position could be either a starting location if the proposed solution will be used instead of the GPS, or the last known solution before a GPS-denied condition occurred. The solution further requires an inexpensive sensor to track local motion of the traveler/navigator or vehicle for which the position is to be determined for extremely short periods of time. It then employs a mathematical (high level) algorithm in conjunction with a reference to compute the updated position, which then becomes the new known position, and the repetition of the procedure follows. The inexpensive sensor can be, for example, a MEMS IMU, a local camera, or any of the other sensors mentioned above. Since the objective of the inexpensive sensor is only to measure local motion for extremely short periods of time, the accuracy limitation described above is not an issue.

The mathematical algorithm utilizes a reference, or a set of references, that is created by the algorithm itself at start-up. The reference requires no measurements or external updates and is therefore independent of the environment in which the INS is intended to work. Throughout the description that follows, the reference is called a virtual celestial object (VCO). Using a VCO to aid in obtaining accurate PNT information is a feature of the present invention. VCOs can be any celestial object for which an elliptical orbit can be computed, such as satellites, planets, or combinations.

The choice of the VCO employed, i.e., the kind of VCO created at the start of the algorithm, determines the kind of data generated and establishes the mathematical tools used in the algorithm. Artificial satellite data includes distances, and so require corresponding tools. Planets cannot work with distances because they are too far and so all have the same distance for small changes of time. Planet data includes angle, and so require corresponding tools. Mathematical tools that can be employed by the present invention include, but are not limited to, Kalman filtering, signal processing, spherical trigonometry, theory of mechanisms, least squares, classical geometry and trigonometry, classical calculus, optimization theory, linear algebra, and control theory.

The large number of possible VCO and mathematical tool combinations makes it impossible to provide an exhaustive description. Without any loss of generality or implied limitation on the scope of the present invention, an exemplary embodiment of the present invention will only be used for clarification. Those skilled in the art will recognize the obvious generalizations.

In the GPS-denied scenario embodiment of the present invention, the initial position and associated time is the last known position of the traveler/navigator or vehicle before the GPS-denied scenario developed. Throughout the present specification, the traveler/navigator or vehicle associated with the GPS receiver is referred to as the “observer”.

In other embodiments, where the invention is used to obtain PNT information more frequently than that available with the GPS, the initial position and time is any known position/time where/when the present invention is going to start being used. The latter also applies if the invention is going to be used as a warning against spoofing.

It is well known that any celestial object's orbit can be uniquely described by six Keplerian parameters: eccentricity, semi-major axis, inclination, longitude of the ascending node, argument of periapsis, and true anomaly. Only closed elliptical orbits are of interest in the present invention.

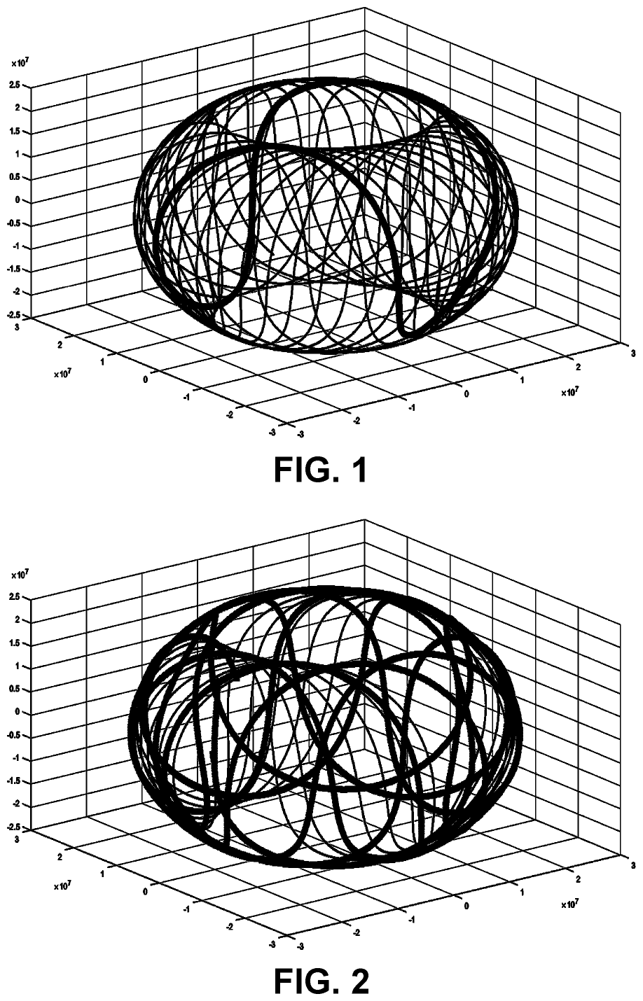

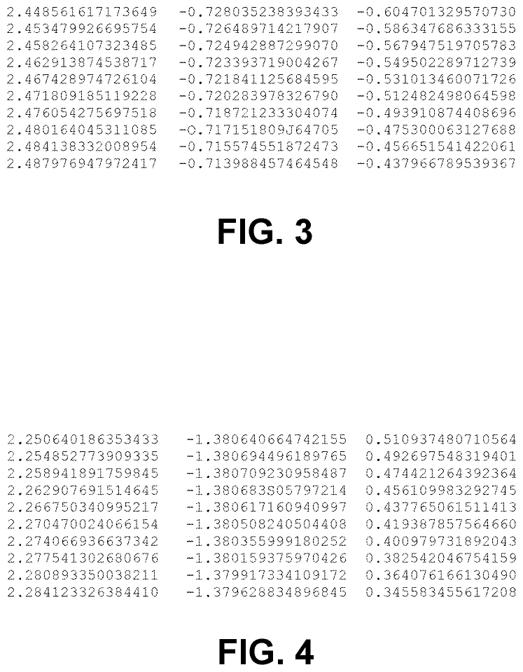

At the start of the algorithm, the six parameters are generated for as many VCOs as are needed in the application. For the sake of clarity, assume that four VCOs will be used. There are many ways to generate the six orbital parameters for these VCOs. One simple way consists of randomly generating the parameters from uniform distributions, where the maximum and minimum values of the distribution are those associated with typical orbital elements. For example, if one wishes the VCOs to emulate satellites, the maximum and minimum values can be those found among the satellites of a constellation. FIGS. 1 and 2 show a sample of satellite orbits compared to VCO generated orbits. FIGS. 3 and 4 show a few numerical samples of the orbit position vectors, in ECEF coordinates, for satellites and VCOs. Depending on the application, the whole orbit for the VCOs can be generated at initialization, with the number of periods selected according to the needs of the application, or it can be generated in real time as required.

The Gibbs method is a way of predicting an orbit using three geocentric position vectors. In the so called Lambert's problem, an orbit is determined from two position vectors and the time between them. Both the Gibbs and Lambert procedures are based on the fact that two-body orbits lie in a plane. For VCOs of the present invention, using the Gibbs method for example, one only needs to provide three different positions that one would like a VCO orbit to pass through (choosing a “typical” pseudorange, say 22,000 miles, and two other pseudoranges “close” to it), and then apply the appropriate algorithm.

In the GPS-denied scenario embodiment and with the VCOs generated to emulate satellites, the VCOs' orbit information directly replaces that of the actual satellites. That is, the virtual orbits' information, the position of the VCOs, can be used as a direct replacement for the GPS satellites' orbit information that would have been used to find the observer's location using equation system (1). The solution of equation system (1) found using the VCO's orbits directly replace the solution that would have been found solving equation system (1) using satellite orbit information.

There are several benefits to this approach. First, there is no need for any kind of observations or measurements of the reference, which in general is what limit the application of INS approaches without GPS. Second, the acquisition of the VCOs is immediate; there is no waiting for an iterative procedure to acquire satellites. Third, VCOs are always available regardless of weather conditions or environment. Fourth, the “acquisition” of the virtual orbits does not result in errors that are typically associated with the GPS-receiver system, namely, ionospheric delay, tropospheric delay, and multi-path.

Since the VCOs' orbit information directly replaces that of the actual satellites, the same equation system (1) employed in the GPS receiver to solve for the observer's position can continue to be used. For illustrative purposes only and recalling the assumption that four VCOs are being used, consider that the position of the observer can be obtained by solving the following inexact system of four equations and four unknowns:

$$PR ( i ) + T \approx \sqrt{{( X - {X}_{VCO} ( i ) )}^{2} + {( Y - {Y}_{VCO} ( i ) )}^{2} + {( Z - {Z}_{VCO} ( i ) )}^{2}} \qquad ( 2 )$$

where X_{VCO}(i), Y_{VCO}(i), and Z_{VCO}(i) are the coordinates of the VCOs for i=1,2,3,4; PR(i) are the pseudoranges from the observer position to the four VCOs; X,Y,Z is the unknown three-dimensional position of the observer; and time T is unknown. Even though equation (2) is an equation of distances, it is customary to write the equation as shown, to emphasize that time T is an unknown variable. To convert to distance, T is multiplied by the speed of light, c.

Just like in the GPS receiver, the pseudoranges used in equation (2) are approximate values. At the start of the GPS denied condition, the position of the observer is known, and since the orbits of the VCOs are also known, having been algorithmically generated, the pseudoranges can be computed exactly. Once the observer moves, for a small interval of time, delta time, the pseudorange does not change much, and can be used as a starting value to solve equation (2) at time=initial time+delta time, iteratively.

In the actual physical receiver-GPS system, the T in equation (2) represents the time the signal takes to travel from the satellite to the receiver. It is also an approximation since there is only one T in the system of equation (2), but the distances from the four satellites to the observer are not all the same, and hence the travel time is also different. In the VCOs' equations (2), there is no travel time since there are no actual satellites for the signal to travel from. There is, however, some computation time, and even though it is small, equation (2) can be left as shown.

For the GPS-denied scenario, the VCOs' orbit information can be used directly instead of the satellite orbit information. This is true not only for any INS implementation, but also for any other application that would use GPS satellite orbit information.

The application of the VCO's to find the observer's position relies on the local sensor to find out that the observed moved, and to obtain an initial estimate of the observer's position.

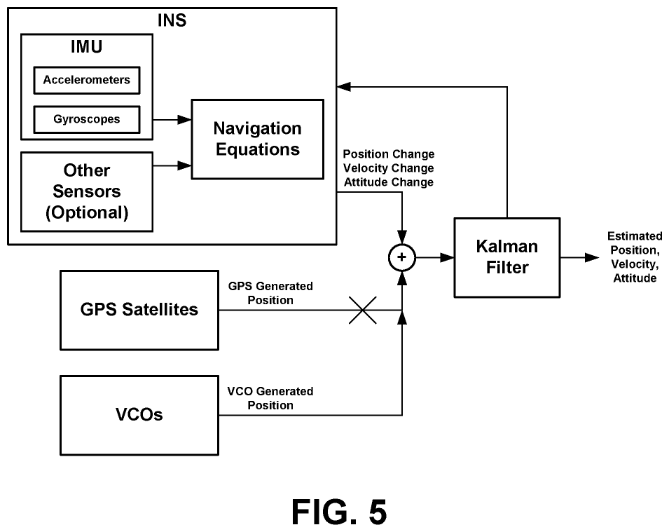

As illustrated in FIG. 5, the inexpensive sensor, such as an IMU, is used to propagate the navigation equations, and the position information provided by the VCOs is used to periodically correct the navigation equations. Consider the following two scenarios.

In the first scenario, if the inexpensive sensor data can be translated into information that says where the observer moved, i.e., the inexpensive sensor provides “distance and direction,” then using the system of equations (2) with the VCOs information (that is, with the position/coordinates of the VCOs at time=initial time+delta time), along with the observer's position provided by the inexpensive sensor and the pseudoranges (calculated using the quantities just mentioned), rapidly provides a corrected position of the observer at time=initial time+delta time.

In the second scenario, if all the inexpensive sensor can determine is that the observer moved, but that movement cannot be translated into information of where the observer moved (e.g., the observer moved a number of feet anywhere around a circle centered in its previous position), i.e., the inexpensive sensor provides “distance” only, then the system of equations (2) is still used, again with the VCOs information at time initial time+delta time, but this time with the pseudoranges of the previous known position (for a small delta time the pseudorange change is small and the known value at the previous time provides an adequate initial guess) and with the known delta time, to solve iteratively (for example, using Least Squares) for the position of the observer.

In either scenario, the position obtained by solving the system of equations (2) can be used in an INS as direct replacement of the GPS, by fusing the data information of the inexpensive sensor and that of the VCOs by, for example, using a Kalman filter implementation or other estimation technique, that otherwise will diverge if only the inexpensive sensor data is used.

What is different here versus INS implementations with the actual GPS-receiver systems, in addition to the reasons mentioned above, is that the output of the navigation equations can be corrected as often as the computations permit and, therefore, the error caused by the inexpensive sensor can be prevented from growing.

In scenarios that require more frequent updates, even though there may not be a GPS-denied situation, the procedure described above also applies.

Since the information provided by the VCOs directly replaces that of the satellites, the implementation of the computation of the VCO orbits can also benefit by taking into account the concept of dilution of precision, which relates to the spacing between the satellites used for navigation. The closer the satellites, the larger the error due to approximations.

One of the reasons the method described above produces valid navigation information is that there is no “closed form” solution to the PNT problem in general, not even to the PNT problem using GPS, and therefore, all solutions only find approximations. That is, any solution to the PNT problem is just an estimate with an error, and depending on the size of the error, the solution is or is not acceptable. Different solutions generate different kinds of errors and more importantly, avoid other errors. Consider the PNT problem using actual GPS. The mathematical equations governing the problem have errors due to, for example, weather, obstructions, multi-path signals, and metal objects. Choosing to solve the problem using celestial navigation eliminates most of these errors but introduces new ones, such as aberration, parallax, refraction, and proper motion. In the case of the solution proposed here, all these error types are avoided in exchange for errors associated with finding solutions in real-time to non-linear equations using approximation modeling and iterative methods.

The description above is just an exemplification of the technical idea(s) in the present patent. Changes and modifications can be made by those skilled in the art without departing from the essence of the idea(s), and therefore, the embodiments presented here should be understood only as illustrations of the technical idea/s and not as limitations of it/them. More explicitly, the scope of the present invention is not limited by the embodiments presented here. The scope of this disclosure should be construed as being covered by the scope of the claims listed below and all technical ideas (and/or their extensions) falling within the scope of the claims should be understood as being included in the scope of the present patent.

The proposed solution improves current navigation solutions regarding:

(1) the SWnP problem since only one inexpensive sensor is used and most of today's GPS-related applications already use such a sensor;

(2) the jamming and spoofing problem since no signals (RF, audio, light) of an external reference to the INS are used;

(3) the INS use in urban areas (no blockage), or under adverse weather conditions (solar, snow or, rainstorms) since there is no dependence on signals generated externally;

(4) longer availability, that is, no restriction on how long the method can be used, since the proposed solution does not depend on the accuracy of the sensor used and it is not affected by the environment/weather;

(5) availability of (PNT) updates as frequently as needed or desired, even when there is a valid GPS signal;

(6) the complexity problem since the information generated (the observer's location) with the proposed solution (i.e., using the VCOs orbits) can be used as direct replacement of the information generated using GPS satellite orbits, or, in another possible embodiment of the proposed solution, the INS created with the proposed solution can be used in parallel with an existing INS, as a method of warning against jamming and/or spoofing; and

(7) cyber security since no external information other than the initial location and time (or in the GPS-denied application, the location and time when the denied scenario occurs), interact with the proposed INS solution.

Thus, it has been shown and described navigation methods. Since certain changes may be made in the present disclosure without departing from the scope of the present invention, it is intended that all matter described in the foregoing specification and shown in the accompanying drawings be interpreted as illustrative and not in a limiting sense.

1. A method of navigating from a known initial position at a known initial time to a new position at a predetermined delta time of an observer, the method comprising the steps of:
(a) providing a sensor that provides at least one parameter of the motion of the observer from the prior position;
(b) creating a number of virtual celestial objects (VCO) with closed elliptical orbits for a desired degree of accuracy;
(c) generating orbital data for the orbit of each of the VCOs;
(d) receiving the at least one parameter from the sensor at the initial time plus the delta time;
(e) retrieving the orbital data generated in step (c) for the VCOs for the initial time plus the delta time; and
(f) calculating the new position to within the desired degree of accuracy using the initial position, the at least one parameter, and the VCO orbital data.

2. The method of claim 1 further comprising iteratively repeating steps (d) through (f) as the observer moves using the new position as the initial position and the initial time plus the delta time as the known initial time.

3. The method of claim 1 further comprising the step of (g) correcting an inertial navigation system (INS) position by using the new position calculated in step (f) using the VCO orbital data.

4. The method of claim 3 further comprising iteratively repeating steps (d) through (g) as the observer moves using the new position as the initial position and the initial time plus the delta time as the known initial time.

5. The method of claim 1 wherein step (f) is performed by solving the equation system
$$PR ( i ) + T \approx \sqrt{{( X - {X}_{VCO} ( i ) )}^{2} + {( Y - {Y}_{VCO} ( i ) )}^{2} + {( Z - {Z}_{VCO} ( i ) )}^{2}}$$
where i=1, 2, . . . , n where n is the number of VCOs.

6. The method of claim 1 wherein the orbital parameter data is generated randomly from a uniform distribution, where the minimum and maximum values of the distribution are those associated with a constellation of physical satellites.

7. The method of claim 1 wherein the orbital parameter data is generated as needed in real time.

8. The method of claim 1 wherein the orbital parameter data is generated prior to performing steps (d) through (f).

9. The method of claim 1 wherein the sensor provides distance.

10. The method of claim 1 wherein the sensor provides distance and direction.
